(19) United States
(12) Patent Application Publication
(10) Pub. No.: US 2020/0018574 A1
(43) Pub. Date: Jan. 16, 2020

(54) Body Armor Plate

(71) Applicant: Matthew Nash, Grovetown, GA (US)

(72) Inventor: Matthew Nash, Grovetown, GA (US)

(21) Appl. No.: 16/256,470

(22) Filed: Jan. 24, 2019

Related U.S. Application Data
(60) Provisional application No. 62/697,535, filed on Jul. 13, 2018.

(51) Int. Cl. F41H 5/04; B32B 5/26

(52) U.S. Cl. CPC F41H 5/0428; B32B 2260/023; B32B 2571/02; B32B 5/26

(57) ABSTRACT

An improved antiballistic body armor plate for use in bullet resistant vests. The device comprises a plate composed of a fabric configured to prevent a bullet from penetrating the vest to the body of the wearer. The fabric includes at least one layer of a first material, a first intermediate layer composed of kinetic gel material, a second intermediate layer composed of an aerogel material, and a plurality of outer layers, each outer layer including the first material and disposed in a stacked arrangement. The first material includes such properties as heat resistance, a high tensile strength-to-weight ratio, a low density, and elasticity. In one variance, the first material is composed of Kevlar. The combination and arrangement of materials distributes the force of impact from shrapnel or a bullet and protects the wearer from a penetration injury.

### CROSS REFERENCE TO RELATED APPLICATIONS

This application claims the benefit of U.S. Provisional Application No. 62/697,535 filed on Jul. 13, 2018. The above identified patent application is herein incorporated by reference in its entirety to provide continuity of disclosure.

### BACKGROUND OF THE INVENTION

The present invention relates to bullet resistant vests and body armor. More specifically, the present invention provides a layering of material for antiballistic protection having a first layer of a plurality of high tensile synthetic fabric, a second layer of kinetic gel, a third layer of aerogel, and a fourth layer of a plurality of high tensile synthetic fabric. The layers are joined together either through stitching or adhesives and is preferably made of flame-resistant material. The outer layers of the device include fasteners to allow the device to removably attach to a vest or other bulletproof garment, such as a hook and loop or snap assembly.

Traditional plates that are inserted into bulletproof vests can be heavy, and may not absorb any impact for the wearer, potentially leaving bruise marks, and may sometimes even cause injuries due to the force upon impact of a projectile upon the traditional plate, which may cause the wearer to fall or suffer from a concussion. Additionally, due to their heavy weight, traditional bulletproof plates may actually slow down wearers when they are attempting to make quick movements, and are often not offered in full coverage sizes, leaving much of the body unprotected. Accordingly, a device that is configured to effectively protect a wearer thereof from a projectile or an explosion, wherein the device may be worn in any size including a full coverage size, is desired.

Devices have been disclosed in the prior art that relate to plate body armor and bullet resistant protective vest systems. These include devices that have been patented and published in patent application publications. These devices generally relate to composite fabric armor plate assembly construction. These devices, however, fail to disclose a plate that includes at least one inner layer of Kevlar, a kinetic gel material, an aerogel material, and a plurality of outer layers of Kevlar.

In light of the devices disclosed in the prior art, it is submitted that the present invention substantially diverges in design elements from the prior art and consequently it is clear that there is a need in the art for an improvement to existing body armor and bullet resistant protective vest systems. In this regard, the instant invention substantially fulfills these needs.

### SUMMARY OF THE INVENTION

In view of the foregoing disadvantages inherent in the known types of antiballistic plate armor now present in the prior art, the present invention provides a new lightweight, antiballistic plate armor assembly wherein the same can be utilized for providing convenience for the user when assembling a body armor system which is lightweight and also able to absorb and dissipate the impact force of high-velocity projectiles.

It is therefore an object of the present invention to provide a new and improved antiballistic plate armor that has all of the advantages of the prior art and none of the disadvantages. The antiballistic plate armor comprises plurality of layered material including a first layer of a plurality of overlapping high tensile synthetic fibers, a second layer of kinetic gel material, a third layer of aerogel material, and a fourth layer of overlapping high tensile synthetic fabric bound together in concurrent layers laying flush one atop another.

It is another object of the present invention to provide an improved antiballistic plate armor comprising an additional layer of solid antiballistic material such as ceramic tiles.

Another object of the present invention is to provide an improved antiballistic plate armor wherein flame-resistant materials are incorporated.

Yet another object of the present invention is to provide an improved antiballistic plate armor wherein the outer layers of the device include a fastening means, such as a hook and loop attachment system or a snap fastener, to secure the plate armor to a vest or article of apparel.

Other objects, features and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the improved body armor plate showing each constituent layer of material.

FIG. 2 shows a deconstructed view of an embodiment of the improved body armor plate showing each constituent layer of material.

FIG. 3 shows a perspective view of an embodiment of the improved body armor plate assembled and interacting with a projectile.

FIG. 4 shows a perspective view of an embodiment of the improved body armor plate assembled with constituent layers showing.

FIG. 5 shows a perspective view of an embodiment of the improved body armor plate installed in a bulletproof vest.

### DETAILED DESCRIPTION OF THE INVENTION

Reference is made herein to the attached drawings. Like reference numerals are used throughout the drawings to depict like or similar elements of the improved body armor plate. For the purposes of presenting a brief and clear description of the present invention, the preferred embodiment will be discussed as used for assembling the constituent layers of the improved body armor plate into a unitary component to be included in a bulletproof vest. The figures are intended for representative purposes only and should not be considered to be limiting in any respect.

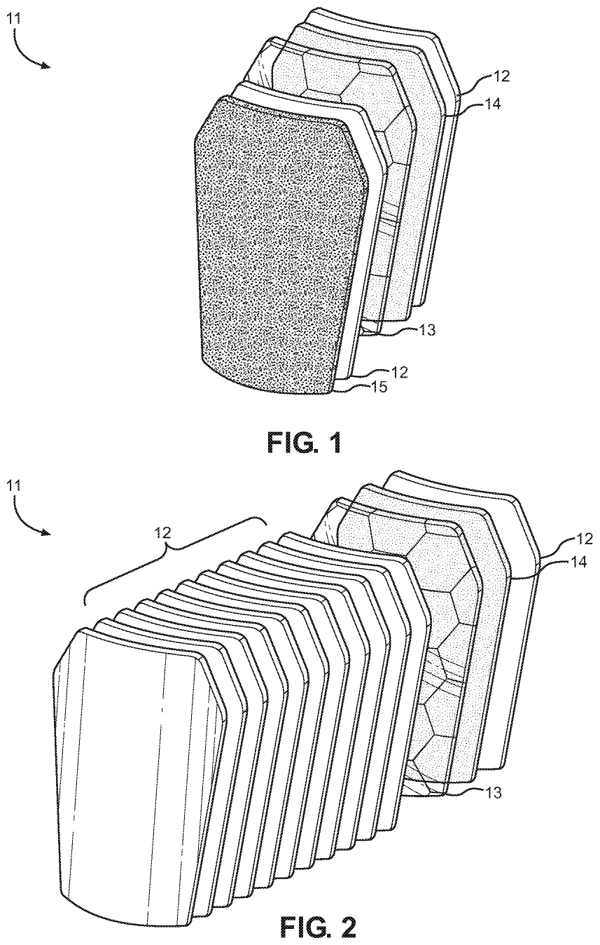

Referring now to FIGS. 1 and 2, there is shown a perspective view of an embodiment of the improved body armor plate showing each constituent layer of material and a deconstructed view of an embodiment of the improved body armor plate showing each constituent layer of material, respectively. The improved body armor plate 11 comprises a system of layers of material formed together to provide an antiballistic surface 17 suitable for inclusion in bulletproof vests 16 and similar devices. Constituent layers include a plurality of high-tensile synthetic fiber fabrics 12, as well as layers of kinetic gel material 13 and aerogel material 14 designed to absorb and dissipate the impact energy of high velocity projectiles 18. An embodiment of the improved body armor plate 11 would comprise an assembled device having a first layer comprised of a plurality of high tensile synthetic fabrics 12 followed by a second layer comprised of an aerogel material 14, a third layer comprised of kinetic gel material 13, and finally a fourth layer comprised of a plurality of high tensile synthetic fibers 12. In some embodiments, the constituent layers would be bound together using a resin and constructed out of fire-resistant materials.

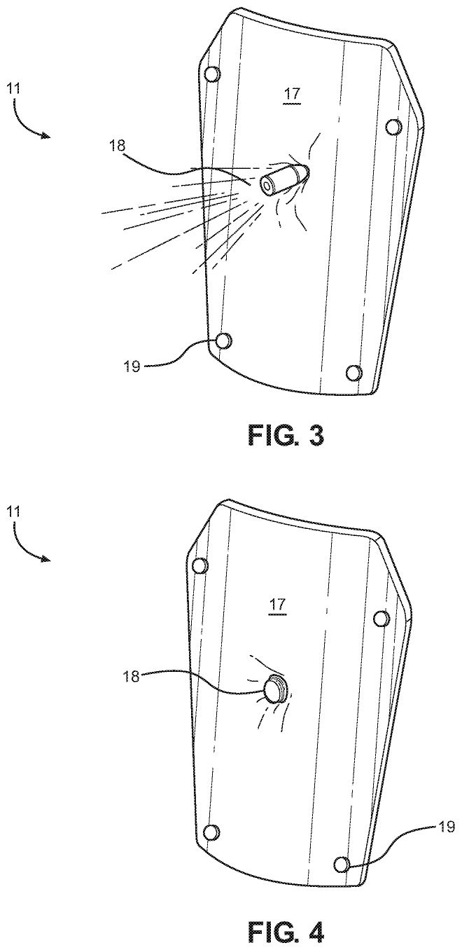

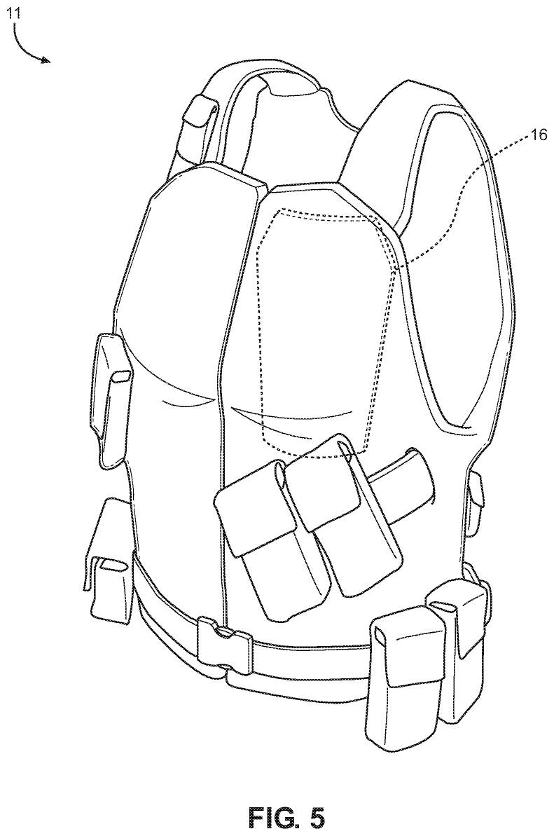

Referring now to FIGS. 3 and 4, there is shown a perspective view of an embodiment of the improved body armor plate assembled and interacting with a projectile and a perspective view of an embodiment of the improved body armor plate assembled with constituent layers showing, respectively. Each layer of the improved body armor plate 11 is overlaid and bound to the subsequent layer such that a unitary material is made into an antiballistic system suitable for inclusion in bulletproof arrangements. The layers may be held together by adhesives or stitching. Fasteners 19 disposed on the exterior of the plurality of layers allow for a user to removably attach the improved body armor plate 11 to an antiballistic vest. An embodiment of the present invention may include additional layers of solid antiballistic material such as ceramic tile 15 while the high tensile synthetic fabric 12 may be made from an aramid structure fabric or any other suitable material.

Referring now to FIG. 5, there is shown a prospective view of an embodiment of the improved body armor plate installed in a bulletproof vest. Each layer of high tensile synthetic fabric 12 is composed of multiple plies of the fabric laid over itself to the desired level of thickness. A fastener 19 is disposed on the outer layers 17 of the device, such as a hook and loop or snap assembly system. The improved body armor plate 11 is designed to stop bullets 18 and other high velocity projectiles by allowing the outer layer 17 to stop the projectile from penetrating the material wherein the kinetic gel 13 and aerogel materials 14 soften the blow and dissipate the energy of the impact while also being lightweight and easy to carry.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) An improved antiballistic body armor plate, comprising:
a plurality of layers, the combination of which being suited for the stopping of a projectile and absorption and dissipation of impact energy;
wherein a first layer is comprised of a plurality of overlapping high tensile synthetic fiber fabrics;
wherein a second layer is comprised of a kinetic gel material;
wherein a third layer is comprised of an aerogel material;
wherein a fourth layer is comprised of a plurality of overlapping high tensile synthetic fiber fabrics, wherein each layer of the plurality of layers is concurrently laid flush over one another and bound together.

2) The improved antiballistic body armor plate of claim 1, wherein an additional layer of ceramic tile is included.

3) The improved antiballistic body armor plate of claim 1, wherein an additional layer of solid antiballistic material is included.

4) The improved antiballistic body armor plate of claim 1, wherein the plurality of layers are bound together using resin.

5) The improved antiballistic body armor plate of claim 1, wherein the plurality of layers are composed of flame-resistant materials.

6) The improved antiballistic body armor plate of claim 1, wherein the high tensile synthetic fiber is woven using an aramid fabric.

7) The improved antiballistic body armor plate of claim 1, wherein fasteners to allow the device to removably attach to a vest or article of apparel are disposed on an external surface of the improved antiballistic body armor plate.

8) The improved antiballistic body armor plate of claim 6, wherein the fastener comprises a hook and loop attachment system.

9) The improved antiballistic body armor plate of claim 6, wherein the fastener comprises a snap fastener assembly.
